(19) United States
(12) Patent Application Publication
(10) Pub. No.: US 2026/0070496 A1
(43) Pub. Date: Mar. 12, 2026

(54) Portable Hanging Television Stand Device

(71) Applicant: Matthew Washington, Houston, TX (US)

(72) Inventor: Matthew Washington, Houston, TX (US)

(21) Appl. No.: 19/324,877

(22) Filed: Sep. 10, 2025

Related U.S. Application Data
(60) Provisional application No. 63/692,864, filed on Sep. 10, 2024.

(51) Int. Cl. B60R 11/02; B60R 11/00

(52) U.S. Cl. CPC B60R 11/0235; B60R 2011/004; B60R 2011/0056; B60R 2011/0057

(57) ABSTRACT

A portable hanging television stand device is provided. The device is comprised of a frame with two parallel frame members connected by at least one cross member. The frame members are preferably J-shaped, with a curved fastener area at the top of each member for hanging the device on various surfaces, such as a vehicle tailgate or door. The fastener may be curved or take other shapes, with optional secondary fasteners like clips, clamps, or magnets for enhanced attachment. Padding can also be included to prevent surface damage. The cross member provides structural support and may also feature additional fasteners for securing the device to a surface. Additionally, a mounting bracket, either fixed or removable, is attached to the frame, allowing for the attachment of a television through various mounting configurations, accommodating different types of TV mounts.

### CROSS-REFERENCE TO RELATED APPLICATION

The present application claims priority to, and the benefit of, U.S. Provisional Application No. 63/692,864, which was filed on Sep. 10, 2024, and is incorporated herein by reference in its entirety.

### FIELD OF THE INVENTION

The present invention relates generally to the field of television stands. More specifically, the present invention relates to a portable hanging television stand device comprised of a television mounting bracket that can be suspended from a vehicle tailgate or other structure or surface. Accordingly, the present disclosure makes specific reference thereto. Nonetheless, it is to be appreciated that aspects of the present invention are also equally applicable to other like applications, devices, and methods of manufacture.

### BACKGROUND

People who attend tailgating events often bring a television to enhance the experience, allowing them and others to enjoy watching sports or entertainment while eating and drinking. However, setting up a television outdoors in a tailgating environment can present several challenges. One common issue is that small gusts of wind can cause the television to wobble, potentially tipping over and resulting in significant damage to the screen and its internal components. Additionally, traditional television stands may not be designed for portability, making them cumbersome to transport and assemble at a tailgate site. Further, some stands can be complicated and time-consuming to set up, detracting from the fun and convenience of the event.

In situations where a proper stand is unavailable, attempting to free-stand the television on an uneven surface, such as a parking lot or grassy field, increases the risk of the TV falling over. This not only jeopardizes the safety of the television but also puts any nearby equipment or people at risk. As a result, a sturdy, easy-to-assemble, portable solution is essential for preventing damage to the television and ensuring a safe, enjoyable tailgating experience.

Therefore, there exists a long-felt need in the art for an improved television stand. There also exists a long-felt need in the art for a portable hanging television stand device. Further, there exists a long-felt need in the art for a portable hanging television stand device that can be used to hang a television at an outdoor event such as, but not limited to, a tailgate. More specifically, there exists a long-felt need in the art for a portable hanging television stand device that can be used to hang a television at an outdoor event such as, but not limited to, a tailgate, wherein the device minimizes the risk of the television being knocked over or damaged.

The subject matter disclosed and claimed herein, in one embodiment thereof, comprises a portable hanging television stand device. The device is comprised of a frame with two parallel frame members connected by at least one cross member. The frame members are preferably J-shaped, with a curved fastener area at the top of each member for hanging the device on various surfaces, such as a vehicle tailgate or door. The fastener may be curved or take other shapes, with optional secondary fasteners like clips, clamps, or magnets for enhanced attachment. Padding can also be included to prevent surface damage. The cross member provides structural support and may also feature additional fasteners for securing the device to a surface. Additionally, a mounting bracket, either fixed or removable, is attached to the frame, allowing for the attachment of a television through various mounting configurations, accommodating different types of TV mounts.

In this manner, the portable hanging television stand device of the present invention accomplishes all the foregoing objectives and provides an improved television stand. More specifically, the device can be used to hang a television at an outdoor event such as, but not limited to, a tailgate. While doing so, the device minimizes the risk of the television being knocked over or damaged.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable hanging television stand device. The device is comprised of a frame preferably comprised of two parallel and spaced-apart frame members connected by at least one cross member. In the preferred embodiment, the frame member is preferably J-shaped with a fastener in the form of a curved hook positioned at a top end of the frame member that allows the device to be hung over the side of a surface or structure such as, but not limited to, a vehicle tailgate, a door, or any other structure or non-traditional surface.

In one embodiment, the fastener may additionally or alternatively be comprised of a secondary fastener such as, but not limited to, a clip, a clamp, a magnet, a suction cup, etc., to further secure the fastener (and frame member to/around an object in a suspended manner). In one embodiment, the member and/or fasteners may be comprised of at least one padding that is positioned between the member and/or fasteners and the surface it is suspended from to prevent the same from damaging the surface.

The cross member provides structural rigidity and support between the frame members. In one embodiment, the cross member is comprised of at least one fastener to further secure the device to/around a surface or object in a suspended manner. In one embodiment, the fastener may be comprised of at least one padding positioned between the fastener and the surface to prevent the same from damaging the surface.

At least one mounting bracket is secured to the frame member. The mounting bracket is comprised of at least one opening that allows the fastener to be placed through the bracket and into a television to secure a television to the bracket. The bracket may have openings in any mounting pattern/configuration known in the art.

The present invention is also comprised of a method of using the device. First, a device is provided comprised of a mounting bracket, and a first curved frame member attached to a second curved frame member via a cross member. Then, a television can be secured to the mounting bracket via placing a fastener through an opening of the bracket and into the television. Finally, a fastener of each of the curved frame members can be placed over a surface, an item, an object, or a vehicle to suspend the television from said surface, item, object, or vehicle. In an additional embodiment wherein each fastener has secondary fasteners, the secondary fasteners attach to the surface, item, object, or vehicle to further secure each frame member to said surface, item, object, or vehicle.

Accordingly, the portable hanging television stand device of the present invention is particularly advantageous as it provides an improved television stand. More specifically, the device can be used to hang a television at an outdoor event such as, but not limited to, a tailgate. While doing so, the device minimizes the risk of the television being knocked over or damaged. In this manner, the portable hanging television stand device overcomes the limitations of existing methods and devices used to display televisions in non-traditional environments such as tailgates known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a portable hanging television stand device of the present invention in accordance with the disclosed architecture;

FIG. 2 illustrates a front view of one potential embodiment of a portable hanging television stand device of the present invention in accordance with the disclosed architecture;

FIG. 3 illustrates a flowchart of a method of using one potential embodiment of a portable hanging television stand device of the present invention in accordance with the disclosed architecture; and

FIG. 4 illustrates a flowchart of a method of using one potential embodiment of a portable hanging television stand device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved television stand. There also exists a long-felt need in the art for a portable hanging television stand device. Further, there exists a long-felt need in the art for a portable hanging television stand device that can be used to hang a television at an outdoor event such as, but not limited to, a tailgate. More specifically, there exists a long-felt need in the art for a portable hanging television stand device that can be used to hang a television at an outdoor event such as, but not limited to, a tailgate, wherein the device minimizes the risk of the television being knocked over or damaged.

The present invention, in one exemplary embodiment, is comprised of a portable hanging television stand device comprised of a frame preferably comprised of two parallel and spaced-apart frame members connected by at least one cross member. In the preferred embodiment, the frame member is preferably J-shaped with a fastener in the form of a curved hook positioned at a top end of the frame member that allows the device to be hung over the side of a surface or structure such as, but not limited to, a vehicle tailgate, a door, or any other structure or non-traditional surface.

In one embodiment, the fastener may additionally or alternatively be comprised of a secondary fastener such as, but not limited to, a clip, a clamp, a magnet, a suction cup, etc., to further secure the fastener (and frame member to/around an object in a suspended manner). In one embodiment, the member and/or fasteners may be comprised of at least one padding that is positioned between the member and/or fasteners and the surface it is suspended from to prevent the same from damaging the surface.

The cross member provides structural rigidity and support between the frame members. In one embodiment, the cross member is comprised of at least one fastener to further secure the device to/around a surface or object in a suspended manner. In one embodiment, the fastener may be comprised of at least one padding positioned between the fastener and the surface to prevent the same from damaging the surface.

At least one mounting bracket is secured to the frame member, comprised of at least one opening that allows the fastener to be placed through the bracket and into a television to secure a television to the bracket. The bracket may have openings in any mounting pattern/configuration known in the art.

The present invention is also comprised of a method of using the device. First, a device is provided comprised of a mounting bracket, and a first curved frame member attached to a second curved frame member via a cross member. Then, a television can be secured to the mounting bracket via placing a fastener through an opening of the bracket and into the television. Finally, a fastener of each of the curved frame members can be placed over a surface, an item, an object, or a vehicle to suspend the television from said surface, item, object, or vehicle. In an additional embodiment wherein each fastener has secondary fasteners, the secondary fasteners attach to the surface, item, object, or vehicle to further secure each frame member to said surface, item, object, or vehicle.

Accordingly, the portable hanging television stand device of the present invention is particularly advantageous as it provides an improved television stand. More specifically, the device can be used to hang a television at an outdoor event such as, but not limited to, a tailgate. While doing so, the device minimizes the risk of the television being knocked over or damaged. In this manner, the portable hanging television stand device overcomes the limitations of existing methods and devices used to display televisions in non-traditional environments such as tailgates known in the art.

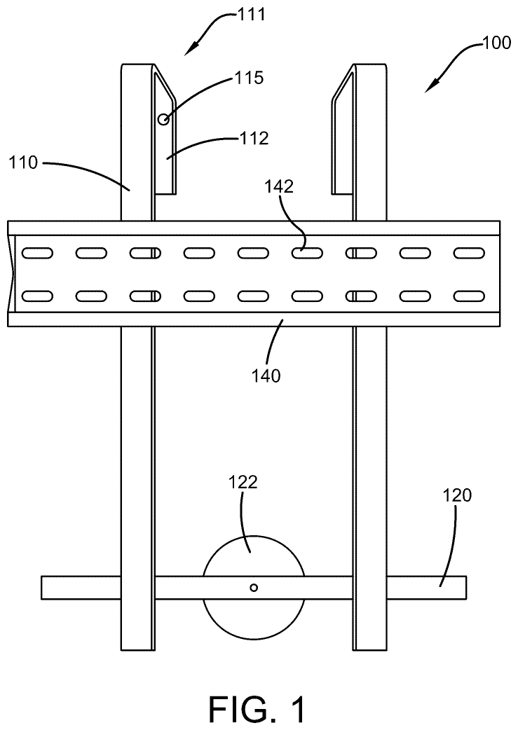

Referring initially to the drawings, FIG. 1 illustrates a front view of one potential embodiment of a portable hanging television stand device 100 of the present invention in accordance with the disclosed architecture. The device 100 is comprised of a frame preferably comprised of two parallel and spaced-apart frame members 110 connected by at least one cross member 120. The frame members 110 and cross member 120 are preferably made from a durable metal or a UV-resistant plastic material. In the preferred embodiment, the frame member 110 is preferably J-shaped with a fastener 112 in the form of a curved hook positioned at a top end 111 of the frame member 110. The fastener 112 allows the device 100 to be hung over the side of a surface or structure such as, but not limited to, a vehicle tailgate, a door, or any other structure or non-traditional surface. It should be appreciated that the fastener 112 may be any shape, such as, but not limited to, an angled fastener with two 90-degree angles, in different embodiments. Although, in the preferred embodiment the fastener 112 is curved.

In one embodiment, the fastener 112 may additionally or alternatively be comprised of a secondary fastener 113 such as, but not limited to, a clip, a clamp, a magnet, a suction cup, etc., to further secure the fastener 112 (and frame member 110 to/around an object in a suspended manner). In one embodiment, the member 110 and/or fasteners 112, 113 may be comprised of at least one padding 114, such as, but not limited to, a felt or a foam padding, that is positioned between the member 110 and/or fasteners 112, 113 and the surface it is suspended from to prevent the same from damaging the surface. In one embodiment, the member 110 is comprised of an opening 115 to allow the member 110 to be fixedly attached to a surface, item, object, etc., via placing a fastener (such as, but not limited to, a bolt, a screw, etc.) through the member 110.

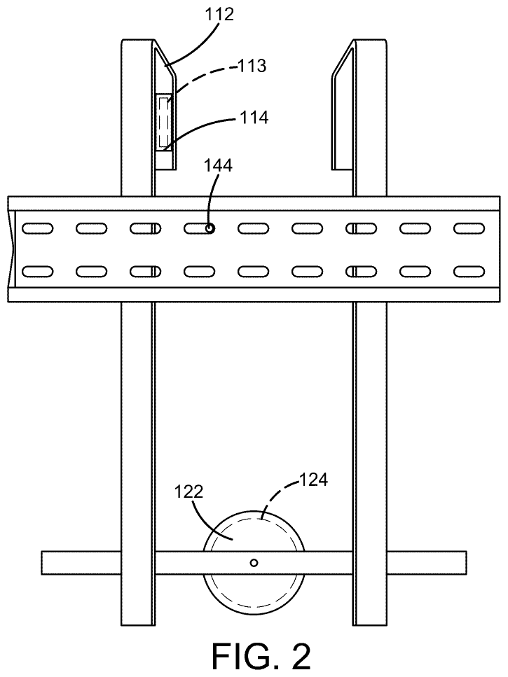

The cross member 120 provides structural rigidity and support between the frame members 110. In one embodiment, the cross member 120 is comprised of at least one fastener 122. The fastener 122 may be, but is not limited to, a clip, a clamp, a magnet, a suction cup, etc., to further secure the device 100 to/around a surface or object in a suspended manner. In one embodiment, fastener 122 may be comprised of at least one padding 124 positioned between the fastener 122 and the surface to prevent the same from damaging the surface, as seen in FIG. 2.

At least one mounting bracket 140 is secured to the frame member 110. In one embodiment, the bracket 140 is fixedly attached to at least one of the frame members 110. In another embodiment, the bracket 140 is removably attached to at least one frame member 110 via at least one fastener 144 such as, but not limited to, a bolt, a bolt and nut assembly, a screw, etc. The mounting bracket 140 is comprised of at least one opening 142 that allows the fastener 144 to be placed through the bracket 140 and into a television to secure a television to the bracket 140. The bracket 140 may have openings 142 in any mounting pattern/configuration known in the art. The bracket 140 may also be any style of TV mounting bracket such as, but not limited to, a fixed mount, a tilting mount, a full-motion mount, a swivel mount, a motorized mount, etc.

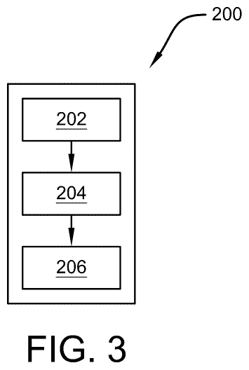

The present invention is also comprised of a method of using 200 the device 100, as seen in FIG. 3. First, a device 100 is provided comprised of a mounting bracket 140, and a first curved frame member 110 attached to a second curved frame member 110 via a cross member 120 [Step 202]. Then, a television can be secured to the mounting bracket 140 via placing a fastener 144 through an opening 142 of the bracket 140 and into the television [Step 204]. Finally, a fastener 112 of each of the curved frame members 110 can be placed over a surface, an item, an object, or a vehicle to suspend the television from said surface, item, object, or vehicle [Step 206].

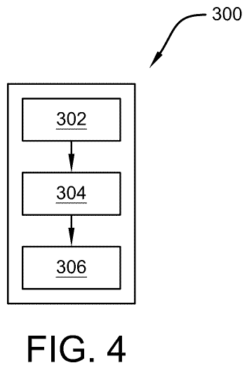

The present invention is also comprised of a method of using 300 the device 100, as seen in FIG. 4. First, a device 100 is provided comprised of a mounting bracket 140, and a first curved frame member 110 comprised of a first fastener 112 comprised of a first secondary fastener 113 attached to a second curved frame member 110 comprised of a second fastener 112 comprised of a second secondary fastener 113 via a cross member 120 [Step 302]. Then, a television can be secured to the mounting bracket 140 via placing a fastener 144 through an opening 142 of the bracket 140 and into the television [Step 304]. Finally, a fastener 112 of each of the curved frame members 110 can be placed over a surface, an item, an object, or a vehicle such that the fasteners 113, 122 contact the surface, item, object, or vehicle to secure and suspend the television from said surface, item, object, or vehicle [Step 306].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable hanging television stand device” and “device” are interchangeable and refer to the portable hanging television stand device 100 of the present invention.

Notwithstanding the foregoing, the portable hanging television stand device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the portable hanging television stand device 100 as shown in the FIGS. are for illustrative purposes only, and that many other sizes and shapes of the portable hanging television stand device 100 are well within the scope of the present disclosure. Although the dimensions of the portable hanging television stand device 100 are important design parameters for user convenience, the portable hanging television stand device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable hanging television stand device comprising:
a cross member;
a first curved frame member;
a second curved frame member attached to the first curved frame member via the cross member; and
a mounting bracket attached to the first curved frame member and the second curved frame member.

2. The portable hanging television stand device of claim 1, wherein the mounting bracket is comprised of an opening.

3. The portable hanging television stand device of claim 1, wherein the mounting bracket is removably attached to the first curved frame member and the second curved frame member.

4. The portable hanging television stand device of claim 1, wherein the first curved frame member is comprised of a first curved hook.

5. The portable hanging television stand device of claim 4, wherein the first curved hook is comprised of a first padding.

6. The portable hanging television stand device of claim 1, wherein the second curved frame member is comprised of a second curved hook.

7. The portable hanging television stand device of claim 6, wherein the second curved hook is comprised of a second padding.

8. A portable hanging television stand device comprising:
a cross member comprised of a first fastener;
a first curved frame member comprised of a first secondary fastener;
a second curved frame member comprised of a second secondary fastener, the second curved frame member attached to the first curved frame member via the cross member; and
a mounting bracket attached to the first curved frame member and the second curved frame member.

9. The portable hanging television stand device of claim 8, wherein the first secondary fastener is comprised of a clip, a clamp, a magnet, or a suction cup.

10. The portable hanging television stand device of claim 8, wherein the second secondary fastener is comprised of a clip, a clamp, a magnet, or a suction cup.

11. The portable hanging television stand device of claim 8, wherein the first fastener is comprised of a clip, a clamp, a magnet, or a suction cup.

12. The portable hanging television stand device of claim 11, wherein the cross member is comprised of a padding.

13. The portable hanging television stand device of claim 8, wherein the first curved frame member is comprised of a padding.

14. The portable hanging television stand device of claim 8, wherein the second curved frame member is comprised of a padding.

15. The portable hanging television stand device of claim 8, wherein the first curved frame member is comprised of an opening.

16. A method of using a portable hanging television stand device, the method comprising the following steps:
providing a portable hanging television stand device comprised of a mounting bracket, and a first curved frame member attached to a second curved frame member via a cross member;
securing a television to the mounting bracket via placing a fastener through an opening of the bracket and into the television; and
placing a first fastener of the first curved frame member and a second fastener of the second curved frame member over a surface, an item, an object, or a vehicle.

17. The method of using a portable hanging television stand device of claim 16, wherein the first curved frame member is comprised of a first fastener.

18. The method of using a portable hanging television stand device of claim 16, wherein the first curved frame member is comprised of a padding.

19. The method of using a portable hanging television stand device of claim 16, wherein the second curved frame member is comprised of a second fastener.

20. The method of using a portable hanging television stand device of claim 18, wherein the padding is comprised of a foam or a felt.
